(19) United States
(12) Patent Application Publication
(10) Pub. No.: US 2013/0062024 A1
(43) Pub. Date: Mar. 14, 2013

(54) BLIND WITH ADJUSTABLE FEEDBACK ENERGY

(71) Applicant: Hsien-Te HUANG, Taipei City (TW)

(72) Inventor: Hsien-Te HUANG, Taipei City (TW)

(21) Appl. No.: 13/305,194

(22) Filed: Nov. 28, 2011

(30) Foreign Application Priority Data
Sep. 8, 2011 (TW) 100216822

(51) Int. Cl. E06B 9/50

(52) U.S. Cl. 160/127

(57) ABSTRACT

A blind which is provided with adjustable feedback energy to roll up a curtain autonomously is disclosed. The blind uses primarily a worm-gear pressure regulation device which can be adjusted manually, is assembled at a side of the blind and is exposed outward. The pressure regulation device acts indirectly onto a volute spring of a rolling system to determine a degree of winding of the curtain by the feedback energy. In addition, using introduction of feedback interference, a working speed at the maximum feedback energy can be damped effectively and a speed of rolling back the curtain can be moderated.

### BACKGROUND OF THE INVENTION

a) Field of the Invention

The present invention relates to a blind with adjustable feedback energy, and more particular to a blind which allows a user to easily adjust and increase feedback energy at an exterior part of the blind, when the blind is elastically fatigued as it has been used for a long time. The blind is provided with a damping device to moderate a feedback speed in the beginning of rolling back a curtain and to facilitate adjusting the curtain to align to a middle position.

b) Description of the Prior Art

Referring to FIG. 1 and FIG. 2, the working principle and the fundamental mechanism of the feedback operation of a blind are disclosed. For a blind 1 which stores energy to roll back a curtain 10, a working axis S of a rolling system 2 is combined coaxially with an energy feedback device 3. The energy feedback device 3 is provided with a volute spring 300 which results in a torque when the volute spring 300 changes radially. When a user is to pull down the curtain 10, the force of the curtain 10 will drive the volute spring 300 through a reel 20 to store energy and when the user is to roll back the curtain 10, the feedback energy will be outputted reversely from the volute spring 300 to roll up the curtain 10 immediately.

The blind 1 is provided with a hanging beam 12, two sides of which are provided with brackets 11. The reel 20 is supported coaxially and indirectly by the brackets 11 using positioning holes 110 which are located on the brackets 11, along a same axis of the reel 20. Therefore, the reel 20 is able to rotate on the working axis S to roll up and down the curtain 10.

Referring to FIG. 2, it shows the working principle of the energy feedback device 3. The energy feedback device 3 includes a positioning pivot 30, an end of which is combined with a stopping pier 32 and the other end of which passes through a through-hole 310 provided by a movable round pier 31. The positioning pivot 30 moves relatively to the through-hole 310, whereas the movable round pier 31 and the stopping pier 32 are fixed respectively by two ends of the volute spring 300. After passing through an angular restrictor 4, the positioning pivot 30 is fixed at the positioning hole 110 at the left bracket 11. The positioning pivot 30 can be positioned radially by the positioning hole 110 directly or by sheathing with an axial pier 21. The axial pier 21 is a sheath unit which can deform elastically along an axial direction and an interior of the axial pier 21 provides for axial sliding of a relative end of the positioning pivot 30. After the axial pier 21 has been pressed in by an external force, a vertical position of the corresponding bracket 11 is changed, which facilitates the rolling system 2 and the curtain 10 to escape entirely from the bracket 11 or to be combined with the bracket 11.

An outer circumference of the movable round pier 31 provides for fixing and combining with an inner circumference of the reel 20. An outer surface of the reel 20 provides for combining with an upper end of the curtain 10 to roll the curtain 10. An outer circumference of the stopping pier 32 is movably assembled with an inner circumference of a relative end of the reel 20 through a sliding ring 320; whereas, a cylindrical positioning disc 210, which is assembled at the positioning hole 110, is used to support a center between the reel 20 and the right bracket 11. The positioning hole 110 can support an axis of the reel 20 and is overlapped with the working axis S. When the curtain 10 is brought downward, a component of force is produced to act onto the reel 20 and drive the reel 20 to rotate radially. When the reel 20 rotates, the movable round pier 31 is linked simultaneously to act onto a left side of the volute spring 300; whereas, a right side of the volute spring 300 is fixed by the stopping pier 32. On the other hand, the stopping pier 32 is fixed and combined with the positioning pivot 30 and a radial angle at a left end of the positioning pivot 30 is restricted as the left end is fixed by the left bracket 11. Accordingly, under a condition that the stopping pier 32 is fixed and the movable round pier 31 is driven to move, the volute spring 300 is twisted that an elastic force of the volute spring 300 is changed to store elastic energy.

When a lower end 101 of the curtain 10 is pulled down to a certain height, it is stopped by the angular restrictor, allowing the lower end 101 of the curtain 10 to be positioned at any height.

The angular restrictor operates the reel 20 so that the orientation of the reel 20 can be restricted transiently and the reel 20 is restricted from rotating again, when the lower rim of the curtain 10 is at any height. This restriction device uses a ratchet (not shown in the drawings) or any design that can be used to lock a rotation unit to lock a ratchet wheel, and can be operated to be unlocked when the device is locked.

### SUMMARY OF THE INVENTION

The primary object of the present invention is to provide a blind, wherein the feedback energy of the rolling system to the curtain can be increased by easily adjusting a pressure regulation device which manually adjusts a function of a worm gear set. The pressure regulation device is combined at a side of the bracket that is exposed out of the blind and is coaxially linked with the volute spring of the rolling system to respond to energy, thereby further interfering with a degree of winding of the curtain.

In the present invention, an axial worm is used to act onto an end of the reel for stopping and an outer end of a positioning pivot, which is coaxially combined with the reel, is slidingly provided at the pressure regulation device along an axial direction, allowing the reel to displace transversally to be used to roll up a blind with a lift cord, especially a blind with a slat.

To enable a further understanding of the said objectives and the technological methods of the invention herein, the brief description of the drawings below is followed by the detailed description of the preferred embodiments.

### BRIEF DESCRIPTION OF THE DRAWINGS

FIG. 1 shows a front view of a conventional blind.

FIG. 2 shows an internal structural view of a conventional blind with feedback energy.

FIG. 3 shows a three-dimensional view of a left end of a blind of the present invention.

FIG. 4 shows a schematic view of an appearance of a pressure regulation device which is combined at an outer end of the blind of the present invention.

FIG. 5 shows a cutaway view of the blind of the present invention after combining with the pressure regulation device.

FIG. 6 shows a three-dimensional structural view of an angular restrictor of the present invention.

FIG. 7 shows a structural view of the present invention which is provided with an adjustment knob for external adjustment by rotation.

FIG. 8 shows a schematic view of the present invention which utilizes a slat and a worm to achieve a function of the pressure regulation device.

FIG. 9 shows a structural view of the present invention which is added with a centrifugal damper.

FIG. 10 shows a side view of a main unit of FIG. 9.

FIG. 11 shows a schematic view of the present invention wherein the centrifugal damper is provided with an auxiliary magnetic damping device.

FIG. 12 shows a relation diagram of the magnetic damping device with respect to magnetic elements, according to the present invention.

FIG. 13 shows a relation diagram of the magnetic damping device with respect to elastic elements, according to the present invention.

FIG. 14 shows a structural view of the present invention which is provided with an expansion damper.

FIG. 15 shows an exploded view of the present invention which is provided with a positioning pivot, slidingly located at the pressure regulation device along an axial direction.

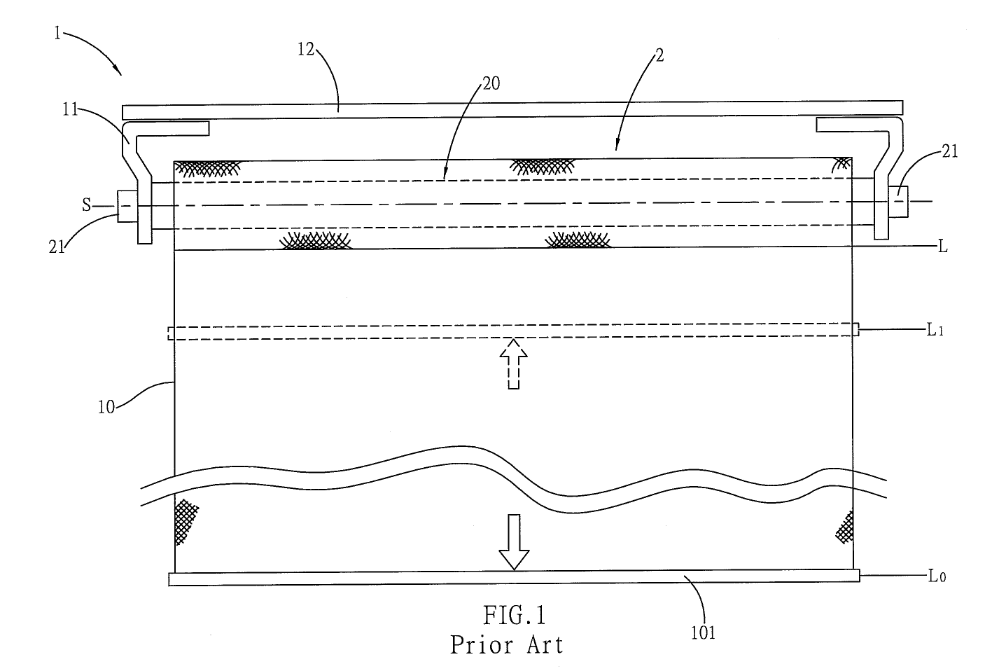

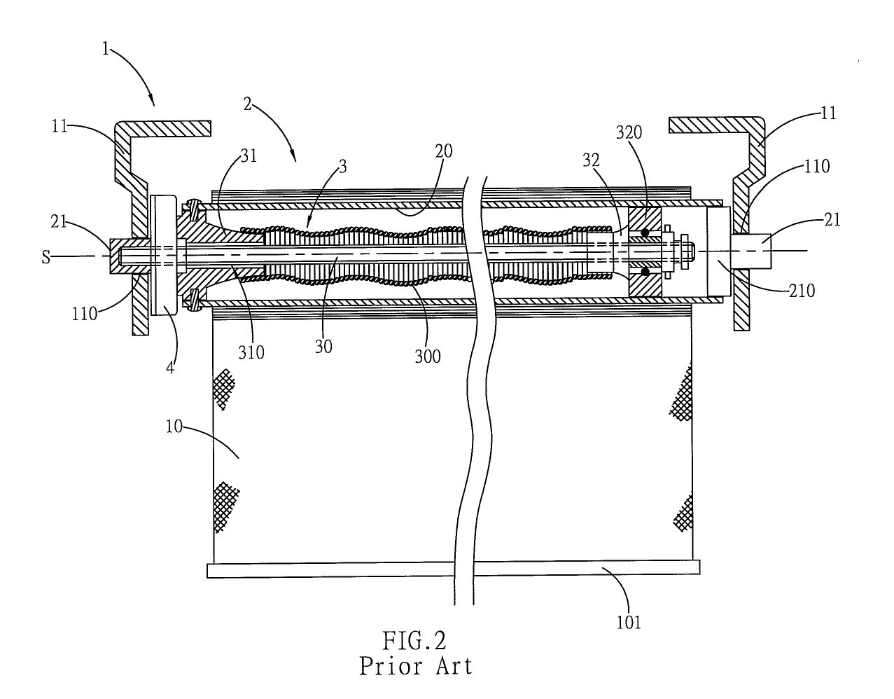

### DETAILED DESCRIPTION OF THE PREFERRED EMBODIMENTS

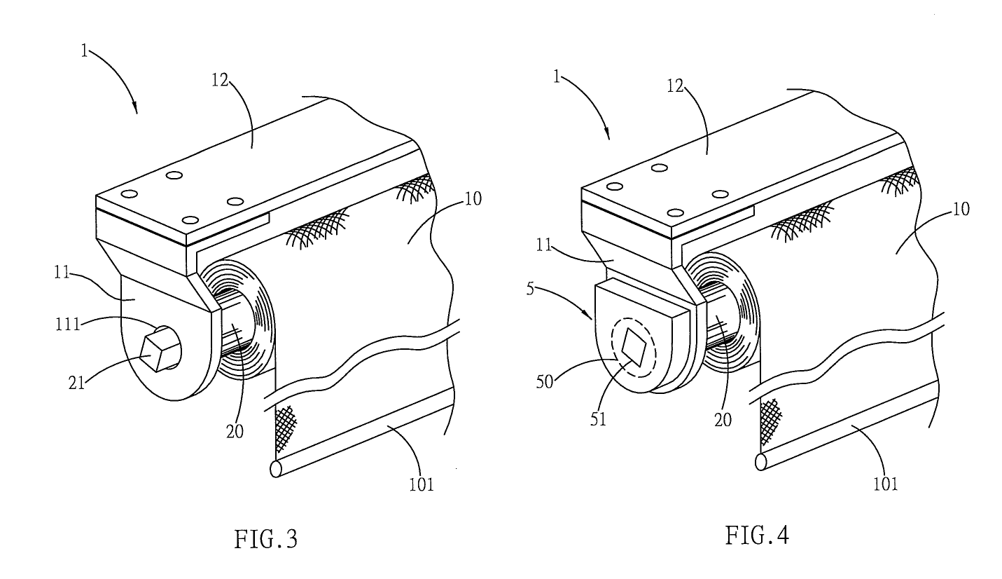

Referring to FIG. 3, the present invention discloses a blind 1 with feedback energy that can be increased manually, wherein a bracket 11 is provided with a through-hole 111 allowing an axial pier 21 to pass through and rotate freely.

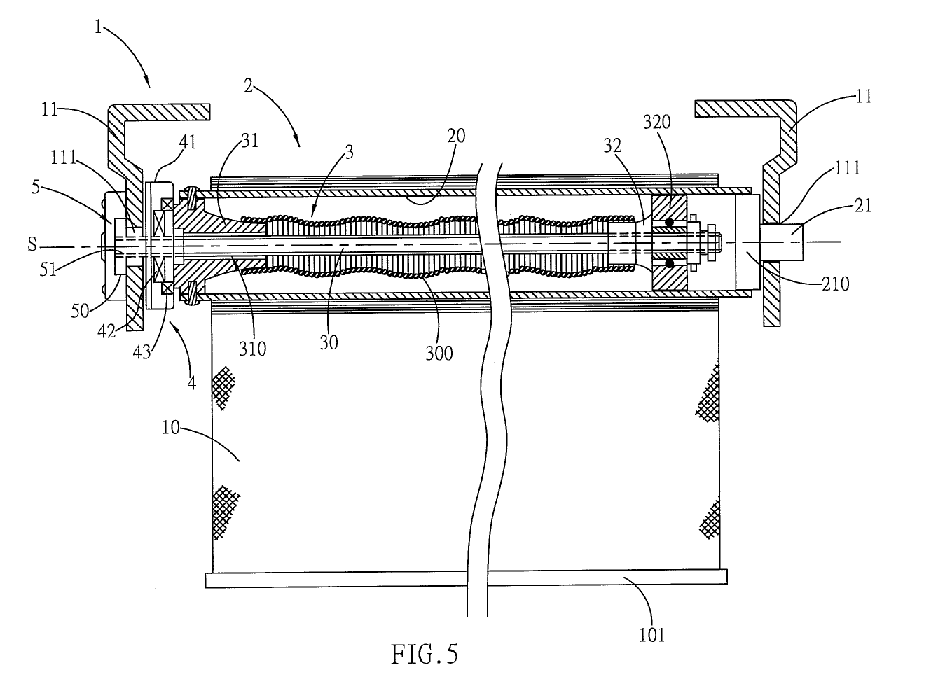

Referring to FIG. 4 and FIG. 5, the blind 1 that rolls up and down a curtain 10 is provided with a hanging beam 12, two sides of which are provided respectively with the bracket 11. An outer end of one bracket 11 is provided with a pressure regulation device 5, an interior of the pressure regulation device 5 is provided with a link disc 50, and a center of the link disc 50 is provided with a latch hole 51. The latch hole 51 links with a positioning pivot 30 which penetrates from a reel 20 and a radial angle of the link disc 50 can be changed by adjusting an external force. The link disc 50 links synchronously with mechanisms inside the reel 20 to result in a change of feedback energy.

The left bracket 11 (as shown in FIG. 5) is combined outward with the pressure regulation device 5 and the latch hole 51 in the center of the pressure regulation device 5 provides for combining with a relative end of the positioning pivot 30 and restricts a radial angle to the entire positioning pivot 30. A mechanical rigidity of the positioning pivot 30 is larger than the feedback energy and a right end thereof is combined with a stopping pier 32 which provides for combining with an end of a volute spring 300; whereas, the other end of the volute spring 300 is combined with a movable round pier 31. A center of the movable round pier 31 is provided with a through-hole 310, allowing the positioning pivot 30 to pass through. The positioning pivot 30 moves relatively to the through-hole 310 and an outer circumference of the stopping pier 32 is movably assembled with an inner circumference of the reel 20 through a sliding ring 320. Therefore, axes of the stopping pier 32 and the reel 20 are overlapped with the working axis. In addition, an inner circumference at a right end of the reel 20 can be supported by a positioning disc 210 which is assembled at the through-hole 111 of the right bracket 11 through the axial pier 21. An outer circumference of the movable round pier 31 provides for combining with the inner circumference at the relative end of the reel 20, and an outer surface of the reel 20 provides for combining with an upper end of the curtain 10 to roll up and down the curtain 10.

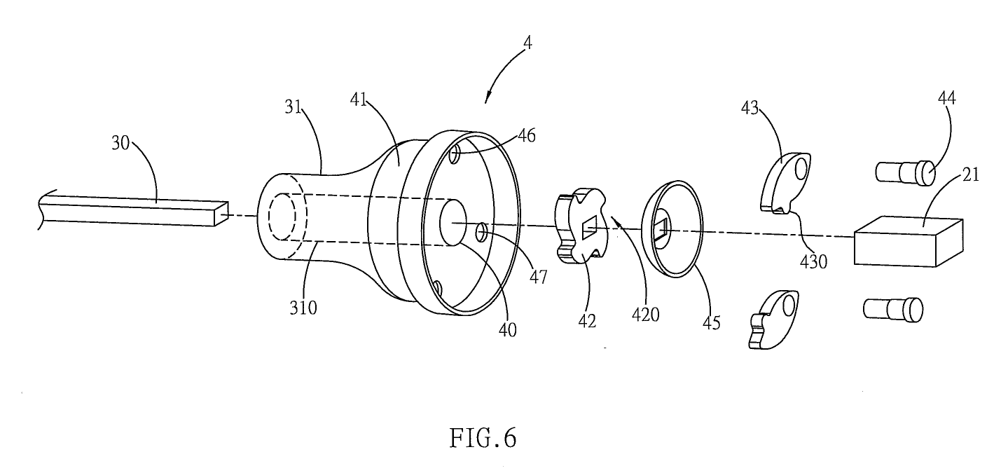

A left end of the movable round pier 31 is assembled with an angular restrictor 4 as shown in FIG. 6. The angular restrictor 4 includes a rotary disc 41 which is assembled with a port of the movable round pier 31. An interior of the rotary disc 41 drives a stator 42 of a centrifugal swing block 43 and the rotary disc 41 is assembled with the positioning pivot 30. Besides, a radial angle of the rotary disc 41 is restricted.

Regarding to the operation of the angular restrictor 4 (a height stopping device), the positioning pivot 30 moves relatively to the through-hole 310 and an outward end of the movable round pier 31 is connected with a rotary disc 41 of the angular restrictor 4; the rotary disc 41 provides for locking and fixing a relative end of the movable round pier 31 through a locking hole 47 and the rotary disc 41 and the movable round pier 31 can be seen as a same unit. A centrifugal swing block 43 swings by gravity and is pivoted at a shaft hole 46 on the rotary disc 41 by a shaft pin 44. A tail end of the centrifugal swing block 43 is provided with a centripetal tooth 430. After passing through the through-hole 310, the positioning pivot 30 is combined with a stator 42 and an outer circumference of the stator 42 is radially provided with a tooth slot 420. In addition, an outer end of the stator 42 is closed by an end sealing piece 45. Therefore, the positioning pivot 30 and the angular restrictor 4 are combined longitudinally and the most tail end of the positioning pivot 30 can be sheathed by the axial pier 21.

As the stator 42 is combined with the positioning pivot 30, the stator 42 is also stopped radially; whereas, the rotation of the movable round pier 31 drives the centrifugal swing block 43 to change angularly and when the movable round pier 31 rotates at a high speed, the centrifugal swing block 43 will swing outward by the centrifugal force, allowing the tooth 430 not to be engaged with the tooth slot 420, which enables the movable round pier 31 to rotate freely. However, when the movable round pier 31 is stationary, under the action of gravity, the tooth 430 of the centrifugal swing block 43 will be engaged downward with the tooth slot 420 of the stator 42. Thus, a radial angle of the movable round pier 31 will be stopped by the indirect engagement of the centrifugal swing block 42, and this effect allows the curtain 10 to be stopped at any height

When the volute spring 300 is elastically fatigued, the user can adjust the pressure regulation device 5 to drive the stopping pier 32 to rotate, which links the volute spring 300 to rotate toward a direction of pressurization, thereby increasing elastic energy of the volute spring 300. The adjustment at this time is that the movable round pier 31 must be stopped and that stopping force can be exerted onto the reel 20 by a way that a lower end 101 of the curtain 10 can be fixed temporarily and thus the movable round pier 31 can be stopped. Under a condition that the movable round pier 31 is stopped indirectly and after the positioning pivot 30 has rotated, the right end of the positioning pivot 30 will drive the stopping pier 32 which drives synchronously the volute spring 300, resulting in a change of radial angle at that end. Therefore, a body part of the volute spring 300 will form a change of elastic pressure, such as the increase of pressure.

On the other hand, when the feedback energy of the volute spring 300 is too large, one can also adjust the pressure regulation device 5 to release the interior elastic pressure, thereby decreasing the feedback energy.

In the present invention, the feedback energy adjustment method especially facilitates adjustment of an elastic torque when the volute spring 300 is elastically fatigued after being used for a long time and helps determination of the feedback energy of the volute spring 300 before leaving a factory without using a pre-determined value to avoid excessiveness or insufficiency; if the feedback energy is excessive, then the lower end 101 of the curtain 10 will hit machine parts at a lower part of the blind 1 when rolling back the curtain 10, whereas if the feedback energy is insufficient, then the lower end 101 cannot be rolled back completely to a highest point.

Using the pressure regulation device 5 of the present invention, there is no need to exercise setting a default torque to the volute spring 300 before leaving a factory. In addition, to the blind 1 to be installed, as different requirements of feedback energy will be available for different masses, the pressure regulation device 5 can be used to adjust proper feedback energy for the requirement of the feedback force corresponding to a specific mass; for example, if the feedback energy is adjusted that the curtain is rolled back to a highest point, then the feedback energy is reset to zero or to a small value, allowing the lower end 101 not to explicitly hit the lower part of the blind 1 and to be positioned correctly. Or, if the feedback energy is not adjusted excessively when leaving a factory, then the pressure regulation device 5 can reduce the feedback energy of the volute spring 300. Therefore, for the blind 1 which is provided with autonomous feedback energy to roll back the curtain, the adjustment of the feedback energy by the pressure regulation device 5 will help simplifying a work procedure before leaving a factory or adjusting the feedback energy according to a practical requirement or increasing the feedback energy when the energy feedback device 3 is elastically fatigued.

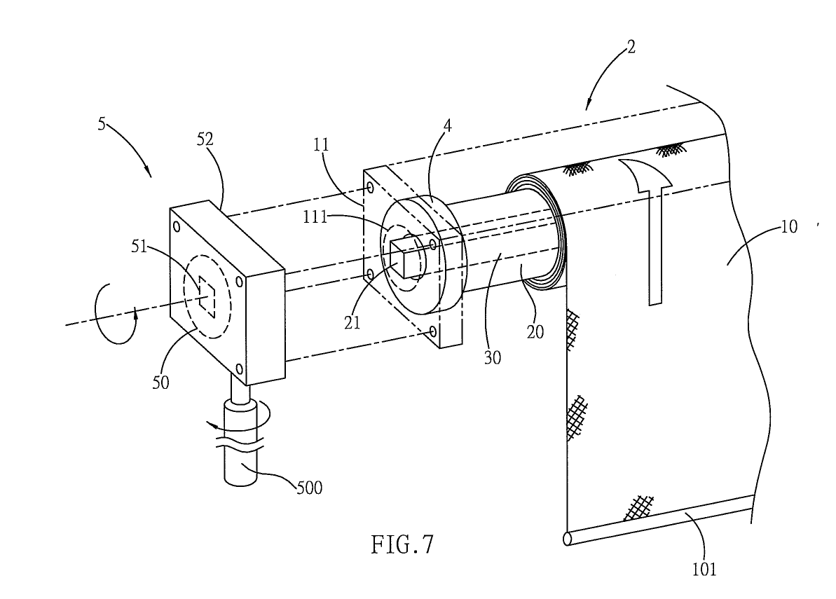

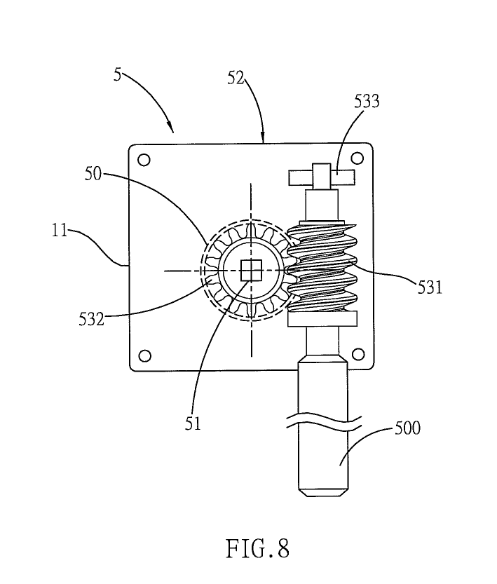

Referring to FIG. 7 and FIG. 8, the pressure regulation device 5 of the present invention is assembled at an outer side of the bracket 11 to facilitate adjustment by the user. The through-hole 111 that is provided axially at the bracket 11 allows the positioning pivot 30 (or the axial pier 21) to pass through, wherein the axial pier 21 is sheathed with the positioning pivot 30 or can pass through the positioning pivot 30 directly to avoid sheathing with the axial pier 21. An interior side of the bracket 11, on the other hand, provides for coaxial assembly with a rolling system 2. The reel 20 of the rolling system 2 is assembled with the angular restrictor 4 and the axial pier 21 which passes through the bracket 11 is latched in the latch hole 51 at the center of the link disc 50. The pressure regulation device 5 is provided with a box unit 52 which is fixed and assembled with the bracket 11. The link disc 50 will result in a change of radial angle through adjustment with an adjustment knob 500. In a mean time, the link disc 50 will drive the axial pier 21 by the latch hole 51, allowing the axial pier 21 to result in a change of angle. The axial pier 21 drives synchronously the positioning pivot 30 to rotate, thereby adjusting the feedback energy as described above.

Referring to FIG. 8 again, the pressure regulation device 5 is a worm gear set which utilizes a higher sliding rate to facilitate adjusting the feedback of a high torque.

The worm-gear pressure regulation device 5 includes a box unit 52, and an axial position is provided with a link disc 50. An outer circumference of the link disc 50 forms a worm gear 532 which provides for gnawing with a worm 531 moving inside the box unit 52. The worm 531 is supported by a seat 533, allowing the worm 531 to keep gnawing with the worm gear 532. The worm 531 is extended outward with an adjustment knob 500 for operation by the user.

After adjustment with the pressure regulation device 5 (as shown in FIG. 5), energy of an energy feedback device 3 can be increased and when the curtain 10 is pulled down to a lowest end, the feedback energy stored in the energy feedback device 3 is largest. In the beginning of rolling back the curtain 10, the maximum power that is outputted by the energy feedback device 3 will roll up the curtain 10 rapidly and then slow down gradually. However, the momentum in the beginning will affect safety of operation elements and the user.

The abovementioned issue is more explicit especially after the adjustment and pressurization through the pressure regulation device 5, wherein in the beginning of roll-back operation, the kinetic energy is very large, causing the curtain 10 to ascend rapidly. To solve this issue, the present invention provides an interference means to slow down the roll-back speed, which is described below.

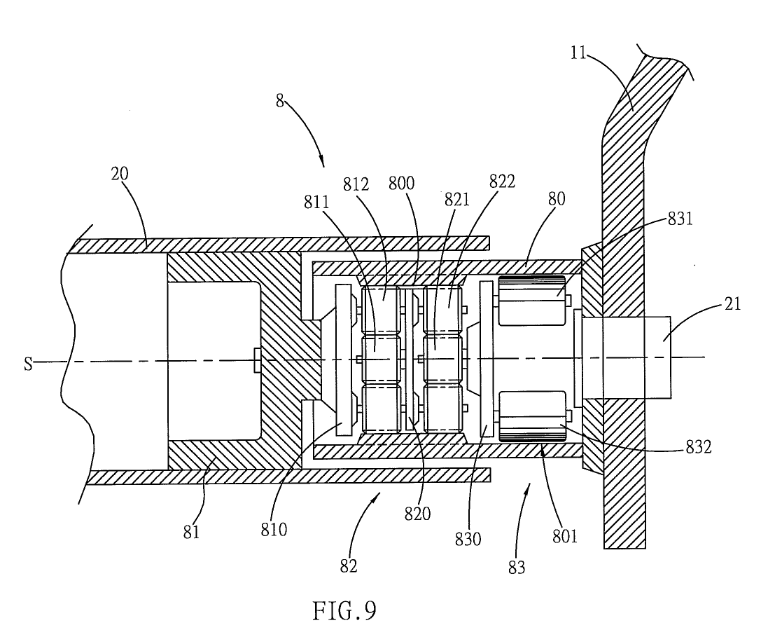

Referring to FIG. 9, a space is yielded from an inner circumference at a right end of the reel 20 to be assembled with a shaft-type centrifugal damper 8. The centrifugal damper 8 is provided with a bracket 11 which is fixed at a side through an axial pier 21, with that a center line thereof is overlapped with the working axis S. An open end at a left side of a fixed barrel 80 is coaxially provided with a sheath barrel 81, an outer circumference of which is fixed at and assembled with the inner circumference of the reel 20 to form a same unit. The sheath barrel 81 links rightward with a set of boosting device 82 along the same axis. The boosting device 82 then drives a set of friction device 83 to result in a damping effect.

A right end of the sheath barrel 81 links with a first planetary disc 810 of the boosting device 82 and the first planetary disc 810 drives a first planetary gear 812. A center of the first planetary gear 812 gnaws concentrically with a first sun gear 811 and an outer circumference of the first planetary gear 812 cuts at an inner gear ring 800 on an inner circumference of the fixed barrel 80. As the inner gear ring 800 is fixed, a rotation speed of the first sun gear 811 is enlarged by 4 times. Moreover, the first sun gear 811 drives rightward a second planetary disc 820 which drives rightward a second planetary gear 822. An outer circumference of the second planetary gear 822 also gnaws at the fixed inner gear ring 800 and a center of the second planetary gear 822 gnaws concentrically with a second sun gear 821. If this second-stage rotation speed is also enlarged by 4 times, then by multiplying by 4 of the first-stage speed, the ratio of the rotation speed of the sheath barrel 81 to that of the second sun gear 821 will be 1:16, which largely increases the terminal speed. This high terminal speed is to meet the requirement of the boost of the centrifugal force.

The high rotation energy acquired by the second sun gear 821 drives a rotation disc 830 which links coaxially at a right end. A periphery of the rotation disc 830 is radially divided by an equal angle with centrifugal swing blocks 831, 832 at an equal radius, of a same shape and a same mass. An outer surface of the centrifugal swing block 831 (832) corresponds to a friction surface 801 which is provided on the inner circumference of the fixed barrel 80. The friction surface 801 is an inner annular surface with a friction effect and is also an elastic surface.

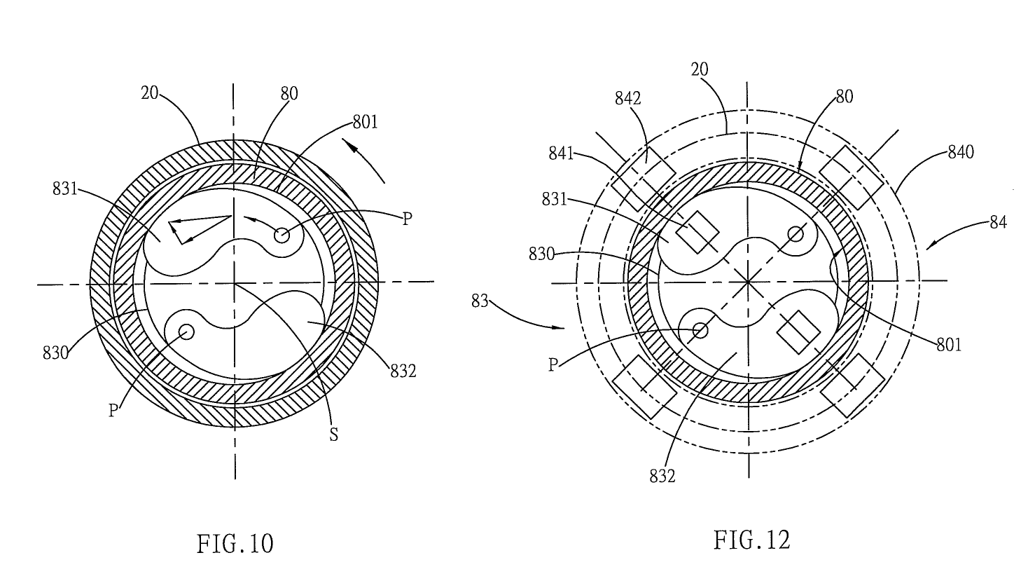

Using the abovementioned structures (as shown in FIG. 9 and FIG. 10), the centrifugal damper 8 includes a fixed barrel 80 which is fixed by a bracket 11. When the reel 20 is driven at a high speed in the beginning of rolling back the curtain, as described above, a rotation system, which links synchronously with the centrifugal damper 8, will first drive the sheath barrel 81. After the sheath barrel 81 has driven the boosting device 82, by increasing the speed with the boosting device 82, the rotation disc 830, which links with the friction device 83, will rotate at a high speed. The rotation disc 830 will then drive the centrifugal swing blocks 831, 832 to result in centrifugal swing. The centrifugal swing blocks 831, 832 are blocks and have masses, with that one end of the centrifugal swing block 831 is bridged at a radius of the rotation disc 830 by a pivot P and the other end is a free end and has a mass. A centrifugal force, which is related to the mass and the rotation speed, is resulted at the free end. The centrifugal force acts on the friction surface 801 of the fixed barrel 80 through the outer surfaces of the centrifugal swing blocks 831, 832 and the resulted friction force will reversely interfere with and consume the rotation energy of the reel 20. Therefore, in the beginning of rolling back the curtain, the maximum energy of the reel 20 can be damped.

Moreover, the size of the centrifugal force of the centrifugal swing block 831 (832) is proportional to the rotation speed of the reel 20; the higher the rotation speed of the reel 20 is, the larger the centrifugal force will be. Therefore, the friction force is also increased simultaneously. The abovementioned phenomenon is properly used in the damping of the reel 20 under high kinetic energy in the beginning of rolling back the curtain, in order to moderate the initial speed of roll back. On the other hand, before the curtain is rolled back to approach to the upper end, the feedback energy is almost depleted. At that time the rotation speed of the reel 20 is slow and the slight friction force is insufficient to reversely interfere with the rotation of the reel 20 again, enabling the reel 20 and the centrifugal damper 8 to correspond equally with each other, in accordance with the requirement of feedback energy. Hence, the centrifugal damper 8 is very well suitable for the blind which is provided with the feedback energy to roll back the curtain.

To intensify the damping capability of the friction device 83, two intensifying devices are implemented to the friction device 83. Referring to FIG. 11, an outer circumference of the fixed barrel 80, relative to the friction device 83, is provided with a magnetic damping device 84. The magnetic damping device 84 is assembled with the fixed barrel 80 through a provided connector 840 and is used to position locations of elements. The magnetic damping device 84 provides for assistance of the damping capability to the friction device 83.

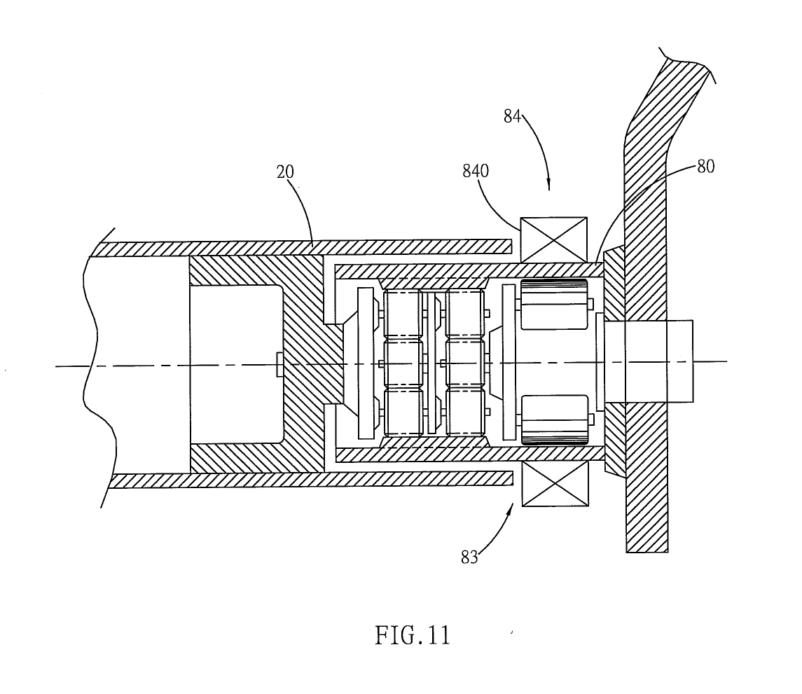

Regarding to the abovementioned assisting system, the present invention proposes two concepts: magnetic or elastic interference. First of all, referring to FIG. 12, it discloses the magnetic interference system. A swing end of the centrifugal swing block 831 (832) is assembled with a movable magnetic unit 841, and a circumference of the connector 840 of the magnetic damping device 84 is radially provided with corresponding fixed magnetic units 842 at an equal angle. The fixed magnetic units 842 are fixed indirectly by the fixed barrel 80. The movable magnetic unit 841 is separated from the fixed magnetic unit 842 by a close distance at which magnetic lines of force can interact and magnetic poles of the two magnetic units are arranged to attract each other.

The centrifugal swing block 831 (832) is driven to result in a centrifugal force, forming a friction force between the centrifugal swing block and the friction surface 801 of the fixed barrel 80 to serve as a first action force for reversely interfering with the reel 20. In addition, a magnetic attractive force between the movable magnetic unit 841 and the fixed magnetic unit 842, when the movable magnetic unit 841 rotates to meet with the fixed magnetic unit 842, is used as a second action force for reversely interfering with the reel 20. The second action force is added to the first action force, summing up with larger reverse interference energy to the reel 20, which can be applied to the blind with high feedback energy.

There is at least one fixed magnetic unit 842 that is provided at an equal angle to increase the magnetic attraction function.

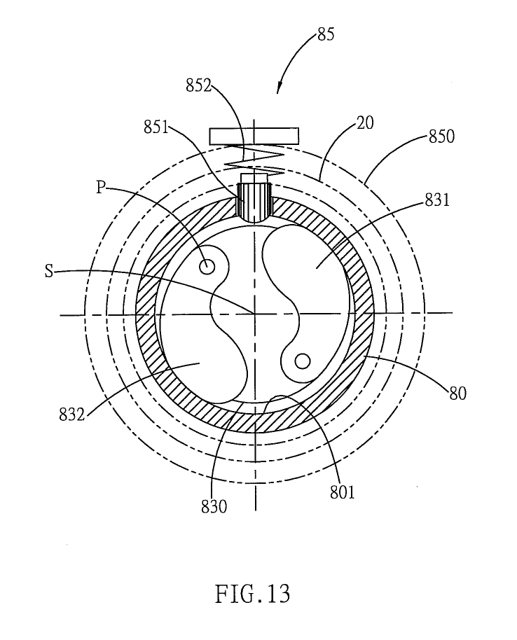

Referring to FIG. 13, another means of damping is to use elastic slashing to deplete kinetic energy of the source.

In this method, the friction surface 801 of the fixed barrel 80 is provided with an elastic damping device 85 which is kept toward the working axis S. The elastic damping device 85 is provided with a friction block 851 and an end surface of the friction block 851 is deep into a radius of the friction surface 801. After the centrifugal swing blocks 831, 832 have been driven, in addition to that the friction damping with the internal surface of the friction surface 801 is used as the first reverse interference action force, a slash action occurs when an outer friction surfaces of the centrifugal swing block 831 (832) cuts at the end surface of the friction block 851 that is deep into the friction surface 801. The slash energy results from the rotation energy of the rotary disc 830 and thus becomes the second reverse interference action force. The second reverse interference action force is added to the first action force, summing up with the rotation energy to reversely interfere with the reel 20, thereby moderating the initial power for rolling back the curtain.

The abovementioned friction block 851 is radially distributed at an equal angle and is positioned on a relative location of the fixed barrel 80 by the connector 850. The friction block 851 can penetrate into a through-hole which is opened at a corresponding position on the fixed barrel 80 and the end surface of the friction block 851 can enter deeply into the radius of the friction surface 801, with that the depth allows the outer surface of the centrifugal swing block 831 (832) to slash and cut through. Besides, the friction block 851 can be fixed on the corresponding position of the fixed barrel 80 through an elastic element 852 which is connected with the connector 850 indirectly.

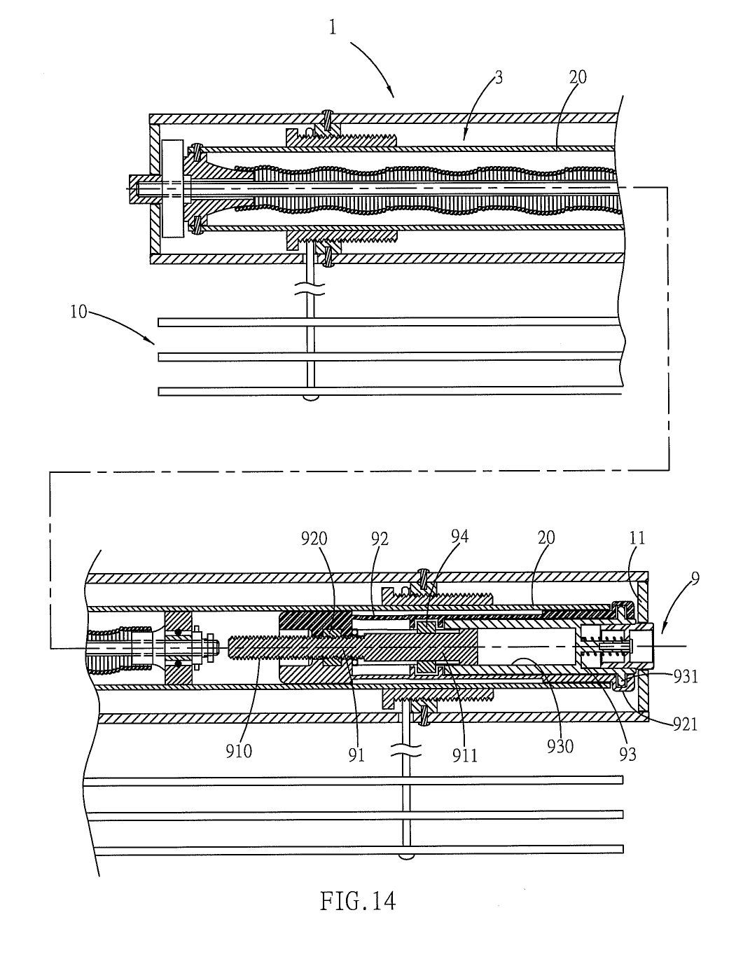

The abovementioned damping method is an explicit dynamic centrifugal damping method. The present invention further provides a more static damping system, as shown in FIG. 14 (in association with FIG. 5).

An interior of a Venetian blind 1 of the present invention is provided with an energy feedback device 3. As the feedback energy can be increased and there is potentially large stored energy, the initial feedback energy will be larger. In addition, as the mass of the curtain is constant, when the user pulls down the curtain to the bottommost end, an interior of the energy feedback device 3 will be accumulated with great stored energy. At the initial moment when the user opens the curtain 10, the power outputted by the feedback energy will be largest, allowing the curtain 10 to ascend rapidly. The last lower end 101 will also be driven toward and to hit the lower part of the hanging beam 12 at a high speed. Therefore, interference has to be exercised for higher feedback energy, so as to reduce the power at that time. However, the stored energy of the feedback device is largest when the curtain 10 is pulled down to the bottommost end, thus at the initial moment when the curtain 10 is opened, the working energy is the largest. In order to moderate the initial feedback power, the present invention further provides an expansion damper 9 which is used in a design to moderate the feedback energy when the energy is largest.

In the present embodiment, an interior of another end of the reel 20 is provided with a shaft-type expansion damper 9. The expansion damper 9 is provide with a fixed end and a working end, the fixed end is assembled at the bracket 11 on the corresponding side through a fixed barrel 93 and a root part of the fixed barrel 93 is provided with an annular shoulder unit 931. An interior of the fixed barrel 93 is provided with a longitudinal slide rail 930, allowing a corresponding end of a passive screw 91 to slide longitudinally. The other end of the passive screw 91 is a thread 910 which is cut at by a female thread 920 on an inner circumference of a link barrel 92. The link barrel 92 is provided with an inner annular positioning slot 921 at a location corresponding to the abovementioned annular shoulder unit 931. The inner annular positioning slot 921 moves relatively to the annular shoulder unit 931 and the link barrel 92 links with the reel 20 to from the working end.

Accordingly, when the reel 20 rotates, it drives synchronously the link barrel 92 to rotate and the female thread 920 of the link barrel 92 will cut at the thread 910 of the passive screw 91. In addition, another end of the passive screw 91 is radially restricted by the slide rail 930 and therefore, the passive screw 91 will not rotate. However, as the thread 910 is acted by the female thread 920 of the link barrel 92, and thus, the passive screw 91 will displace leftward and rightward along an axial direction by being cut at obliquely.

In the abovementioned process of left and right displacement, a bevel function of a cone unit 911 having a push edge is utilized to affect an elastic and frictional expansion ring 94 to result in a change of outer diameter. The change of outer diameter will friction onto a relative surface on an inner circumference of the link barrel 92, forming a damping effect by the friction force and allowing the rotation speed of the link barrel 92 to be restricted.

Using the introduction of the expansion damper 9, the rotation speed of the reel 20 will be affected. The timing of that affection is when the stored energy of the energy feedback device 3 is largest, where the expansion damper 9 can produce the largest interference of rotation damping to the reel 20. On the contrary, when the stored energy of the energy feedback device 3 has been released and weakening, the expansion damper 9 will gradually lose the expansion pressure to the expansion ring 94 due to the retreat of the cone unit 911. Therefore, the interference of the outer circumference of the expansion ring 94 to the inner circumference of the reel 20 will be diminished gradually and by that the friction interference between these two elements is an alternate and progressive relation, the rolling speed of the curtain 10 can be more uniform during the process of rolling up.

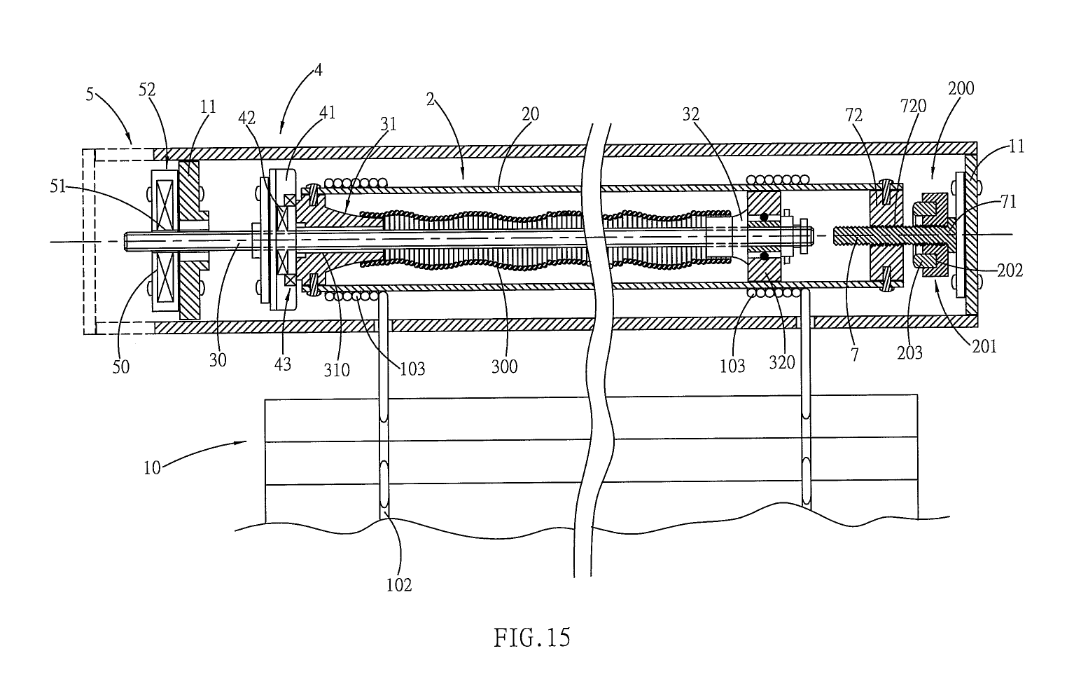

Referring to FIG. 15, the latch hole 51 in the center inside the pressure regulation device 5 provides for latching with the positioning pivot 30 of the rolling system 2. In addition, the latch hole 51 can further provide for slidingly emplacing the relative end of the positioning pivot 30 along the axial direction.

The pressure regulation device 5 is assembled at the outer surface of the bracket 11 through the provided box unit 52 and achieves similarly the adjustment to the angle of the positioning pivot 30 as described above. The right end of the positioning pivot 30 is also assembled with the stopping pier 32 and the outer circumference of the stopping pier 32 is connected indirectly with a sliding ring 320 which is movably assembled on the inner circumference of the reel 20. On the other hand, the left end of the positioning pivot 30 is assembled with the stator 42 of the angular restrictor 4 and forms a longitudinal combination with the angular restrictor 4, as shown in FIG. 6. An end of the provided rotary disc 41 is assembled with a corresponding end of the movable round pier 31 and an outer circumference of the movable round pier 31 provides for assembling with the reel 20.

The positioning pivot 30 can be slidingly provided at the latch hole 51 along the longitudinal direction. However, under a condition that the positioning pivot 30 is radially restricted by the latch hole 51, the positioning pivot 30 can only move left and right that it is restricted radially. The restriction also enables the volute spring 300 to store and adjust the feedback energy as described above.

In this design, the reel 20 rotates radially and can result in an axial displacement by any external force. This displacement allows the left and right edge of the curtain 10 to align to two side edges of a window, i.e., the curtain 10 can be adjusted to be at a center location vertically, which facilitates aligning the curtain 10 to the center.

On the other hand, this axial movement also applies to the curtain 10 with a lift cord 102. The curtain 10 can be the curtain 10 with a slat, a honeycomb blind, a pleated blind or a Roman blind, which is the curtain 10 that requires the lift cord 102, wherein the lift cord 102 is wrapped around a coil 103 on the outer surface of the reel 20 and can be wound orderly.

The axial displacement provided by the present invention is that the right end of the reel 20 is assembled with an end sealing piece 72. A center of the end sealing piece 72 is provided with an inner thread 720 which is cut at by an axial screw 7 fixed on the right bracket 11 by a root part 71. The distance of thread of the axial screw 7 is roughly the same as the cross section of the lift cord 102, and therefore, when the reel 20 turns by one round, the axial screw 7 can provide a feed distance which is roughly the same as the cross section of the lift cord 102 to push the reel 20 to displace axially. Under a condition that the displacement is the same as the cross section of the lift cord 102, the coil 103 after the lift cord 102 has been wrapped around will be next to each other without overlapping.

In the abovementioned design, considering the requirement of detachment of the angular restrictor 4, an axial location of movement of the reel 20 is correspondingly provided with a pre-stopper 200. Using a reserved stroke of the pre-stopper 200, when the curtain 10 is pulled down to the bottommost end when used normally, the added reserved stroke of the pre-stopper 200 can be utilized to further pull down the curtain 10, thereby providing the unlocking stroke required by the angular restrictor 4.

The locking and release actions of the angular restrictor 4 have been disclosed as in FIG. 6 and FIG. 5, wherein the unlocking action of the angular restrictor 4 is conducted by the stroke of further pulling down the curtain 10.

During the normal usage, the curtain 10 that has been pulled down completely can shade light from a window completely. In the normal usage, the user is accustomed to pull down the curtain 10 completely. However, before rolling back, the unlocking is required. If the curtain 10 has been already pulled down to the bottommost, then it cannot be pulled down further to acquire the unlocking stroke, that is, the curtain 10 cannot be rolled back. In the prior art, to enlarge the pull-down stroke of the curtain 10, the curtain 10 will be over a lower rim of the window frame significantly to prevent the user from pulling down the curtain 10 to the lowest point. Yet, as the stroke is reserved significantly, the cost of material will be very high.

To save the material and to solve the issue of lower dead spot, the present invention utilizes a segmentation method to reserve the unlocking stroke, allowing the user to add a unlocking stroke when the curtain 10 is accidentally pulled down to the lowest end.

Regarding to the abovementioned method of adding the stroke, a pre-stopper 200 is provided. The pre-stopper 200 is fixed at the bracket 11 at a side and is provided with an elastic element 203 which is an elastic deformation unit and is fixed inside the bracket 11 by a support disc 201. The support disc 201 is provided with an annular opening 202, allowing the elastic element 203 to be sheathed. An axial deformation value of the elastic element 203 is an amount of increase of the axial displacement of the reel 20 required by the unlocking stroke and meets the rotation angle of unlocking required by the angular restrictor 4. Therefore, under a normal condition, when the user is to open the curtain 10 completely to feel that the light is shaded completely, he or she will accustomedly pull down the curtain 10 completely. During the process of pulling down the elastic element 203, the reel 20 will move right axially and the right end will first press on a relative end surface of the elastic element 203, resulting in a touch message which can be sensed by a hand. Therefore, the user will feel that the curtain 10 has been pulled down completely and this is defined as the pre-sensing stop point in the present design. Under this condition, when the user is to roll up the curtain 10, he or she can pull down the curtain 10 again to enter into the unlocking stroke and reversely operate the angular restrictor 4 to conduct the unlocking action. For this addition of the unlocking stroke, the force exerted should be intensified to resist the deformation force of the elastic element 203, mainly the push force of the end surface of the reel 20 to the end surface of the elastic element 203. After fulfilling the force to be exerted, the angular restrictor 4 will result in a relative change of radial angle and is unlocked. This addition of the unlocking stroke can widen the distance between the right end surface of the reel 20 and the relative inner surface of the bracket 11. The abovementioned requirement can be also satisfied when the curtain 10 has been pulled down completely to the bottommost end, and the right end surface of the reel 20 or the axial stroke has not yet been interfered.

It is of course to be understood that the embodiments described herein is merely illustrative of the principles of the invention and that a wide variety of modifications thereto may be effected by persons skilled in the art without departing from the spirit and scope of the invention as set forth in the following claims.

What is claimed is:

1. A blind with adjustable feedback energy, being provided with a function of storing adjustable feedback energy to roll back a curtain autonomously, comprising:
a hanging beam, two sides of the hanging beam are assembled respectively with a parallel and opposite bracket, a center of a breadth of the bracket being provided with a through-hole aligning to a working axis;
a set of shaft-type rolling system which is provided with an energy feedback device, the energy feedback device including a positioning pivot, an end of the positioning pivot is fixed and assembled with a stopping pier, and the other end of the positioning pivot passes through a through-hole of a movable round pier, the energy feedback device also including a volute spring, two ends of the volute spring are assembled respectively with the movable round pier and the stopping pier, an outer circumference of the movable round pier being fixed and assembled with a corresponding inner circumference of a reel, a corner on an outer circumference of the reel providing for combining with an upper end of a curtain, an outer circumference of the stopping pier being movably and axially connected with the corresponding inner circumference of the reel through a sliding ring, a port at the same end of the reel being assembled with the bracket at the corresponding side through a support center of a positioning disc, the bracket supporting an axis of the reel and the axis being overlapped with the working axis;
a centrifugal angular restrictor which is provided with a stator, a center of the stator providing for penetration of the positioning pivot and a radial angle of the stator being restricted by the positioning pivot, the angular restrictor including a rotary disc which links coaxially with a port of the movable round pier; and
a pressure regulation device which is fixed and assembled at a side of the corresponding bracket and is provided with a link disc, an angle of the link disc being adjustable by an external force, a center of a breadth of the link disc being provided with a latch hole on the working axis, the latch hole providing for latch with a corresponding end of the positioning pivot and fixing a radial angle of the positioning pivot, an outer circumference of the link disc being a worm gear gnawed by a worm and the worm being connected outward with an adjustment knob.

2. The blind with adjustable feedback energy according to claim 1, wherein the latch hold of the link disc is a through-hole and provides for axial sliding of a corresponding end of the positioning pivot, the positioning pivot sliding axially to drive synchronously the reel to slide along an axial direction.

3. The blind with adjustable feedback energy according to claim 2, wherein an axis position on a right end surface of the reel is axially provided with an inner thread which is cut at by an axial screw fixed coaxially at the right bracket.

4. A blind with adjustable feedback energy, being provided with a function of storing adjustable feedback energy to roll back a curtain autonomously, comprising:
a hanging beam, two sides of the hanging beam are assembled respectively with a parallel and opposite bracket, a center of a breadth of the bracket being provided with a through-hole aligning to a working axis;
a set of shaft-type rolling system which is provided with an energy feedback device, the energy feedback device including a positioning pivot, an end of the positioning pivot is fixed and assembled with a stopping pier, and the other end of the positioning pivot passes through a through-hole of a movable round pier, the energy feedback device also including a volute spring, two ends of volute spring are assembled respectively with the movable round pier and the stopping pier, an outer circumference of the movable round pier being fixed and assembled with a corresponding inner circumference of a reel, a corner on an outer circumference of the reel providing for combining with an upper end of a curtain, an outer circumference of the stopping pier being movably and axially connected with the corresponding inner circumference of the reel through a sliding ring, a port at the same end of the reel being assembled with the bracket at the corresponding side through a support center of a positioning disc, the bracket supporting an axis of the reel and the axis being overlapped with the working axis;
a centrifugal angular restrictor which is provided with a stator, a center of the stator providing for penetration of the positioning pivot and a radial angle of the stator being restricted by the positioning pivot, the angular restrictor also including a rotary disc which links coaxially with a port of the movable round pier;
a pressure regulation device which is fixed and assembled at a side of the corresponding bracket and is provided with a link disc, an angle of the link disc being adjustable by an external force, a center of a breadth of the link disc being provided with a latch hole on the working axis, the latch hole providing for latch with a corresponding end of the positioning pivot and fixing a radial angle of the positioning pivot;
a shaft-type centrifugal damper which is provided with a fixed barrel fixed at the corresponding bracket, a center of the fixed barrel being overlapped with the working axis;
and a sheath barrel, an outer circumference of the sheath barrel is assembled with an inner end of the reel, and a center of sheath barrel links with a boosting device, an output end of the boosting device driving coaxially a rotary disc, a breadth of the rotary disc being provided at an equal angle with two centrifugal blocks which swing centrifugally, outer surfaces of the two centrifugal swing blocks frictioning a corresponding friction surface on an inner circumference of the fixed barrel.

5. The blind with adjustable feedback energy according to claim 4, wherein the boosting device is a mechanism to increase a rotation speed of a planetary gear system and is provided with a first planetary disc which links coaxially with the sheath barrel, the first planetary disc being axially pivoted with a first planetary gear at an equal angle and toward an output end, an outer circumference of the first planetary gear cutting at an inner tooth ring at the fixed barrel, the first planetary gear being gnawed with a first sun gear toward a center, the first sun gear linking coaxially with a second planetary disc, the second planetary disc being radially pivoted with a second planetary gear at an equal angle and toward an output end, an outer circumference of the second planetary gear cutting at the inner tooth ring, the second planetary gear being gnawed with a second sun gear toward a center, the first planetary gear linking coaxially with a rotary disc of a friction device, the rotary disc being radially bridged at an equal angle with two centrifugal swing blocks, outer surfaces of the centrifugal swing blocks frictioning a friction surface of the fixed barrel.

6. The blind with adjustable feedback energy according to claim 5, wherein a periphery of the fixed barrel, corresponding to the friction device, is provided with a magnetic damping device which is formed by movable magnetic units at swing ends of the centrifugal swing blocks of the friction device and fixed magnetic units fixed at the periphery of the fixed barrel to attract magnetically the movable magnetic units.

7. The blind with adjustable feedback energy according to claim 6, wherein the fixed magnetic units are distributed radially and by an equal angle.

8. The blind with adjustable feedback energy according to claim 4, wherein an inner circumference of the fixed barrel, corresponding to the friction device, is provided with an elastic damping device which is formed by a friction block in a friction path of the centrifugal swing block of the friction device, the friction block moving elastically along the working axis through a through-hole of the fixed barrel and an end surface of the friction block deeply entering into a radius of the friction surface allowing outer surfaces of the centrifugal swing blocks to slash and cut through.

9. The blind with adjustable feedback energy according to claim 8, wherein the friction block is fixed indirectly with a connector through an elastic element and the connector is fixed relatively with the fixed barrel.

10. The blind with adjustable feedback energy according to claim 8, wherein plural friction blocks are radially provided at a periphery of the fixed barrel at an equal angle.

11. A blind with adjustable feedback energy, being provided with a function of storing adjustable feedback energy to roll back a curtain autonomously, comprising:
a hanging beam, two sides of the hanging beam are assembled respectively with a parallel and opposite bracket, a center of a breadth of the bracket being provided with a through-hole aligning to a working axis;
a set of shaft-type rolling system which is provided with an energy feedback device, the energy feedback device including a positioning pivot, an end of the positioning pivot is fixed and assembled with a stopping pier, and the other end of the positioning pivot passes through a through-hole of a movable round pier, the energy feedback device also including a volute spring, two ends of the volute spring are assembled respectively with the movable round pier and the stopping pier, an outer circumference of the movable round pier being fixed and assembled with a corresponding inner circumference of a reel, a corner on an outer circumference of the reel providing for combining with an upper end of a curtain, an outer circumference of the stopping pier being movably and axially connected with the corresponding inner circumference of the reel through a sliding ring, a port at the same end of the reel being assembled with the bracket at the corresponding side through a support center of a positioning disc, the bracket supporting an axis of the reel and the axis being overlapped with the working axis;
a centrifugal angular restrictor which is provided with a stator, a center of the stator providing for penetration of the positioning pivot and a radial angle of the stator being restricted by the positioning pivot, the angular restrictor including a rotary disc which links coaxially with a port of the movable round pier;
a pressure regulation device which is fixed and assembled at a side of the corresponding bracket and is provided with a link disc, an angle of the link disc being adjustable by an external force, a center of a breadth of the link disc being provided with a latch hole on the working axis, the latch hole providing for latch with a corresponding end of the positioning pivot and fixing a radial angle of the positioning pivot;
an expansion damper which is provided with a fixed barrel fixed at the corresponding bracket, a root part of the fixed barrel being provided with an annular shoulder unit, an axis of the fixed barrel being overlapped with the working axis, an interior of the fixed barrel being provided with a longitudinal slide rail, allowing an end of a passive screw to slide longitudinally and restricting the passive screw not to rotate radially, the passive screw being provided with a thread toward a working end, a waist part of the passive screw being provided with a cone unit, the thread being cut at by a female thread which is assembled with a link barrel, allowing the entire passive screw to displace longitudinally, the link barrel being provided with an inner annular positioning slot at a location corresponding to the annular shoulder unit, the inner annular positioning slot sliding with respect to the annular shoulder unit, an inner circumference of the link barrel being longitudinally fixed with an expansion ring at a location relative to a displacement scale of the cone unit, an inner circumference of the expansion ring slidingly cut at a push bevel of the cone unit, an outer circumference of the expansion ring being expanded to friction on a corresponding inner circumference of the link barrel, and the outer circumference of the link barrel being sheathed with an inner circumference of the reel.

12. The blind with adjustable feedback energy according to claim 11, wherein an inner surface of the bracket, opposite to an end surface of the reel, is provided with a pre-stopper which includes an elastic element, an end of the elastic element being assembled at an inner side of the bracket and the other end of the elastic element facing an end surface of the pre-stopper.
